(19) United States
(12) Patent Application Publication
(10) Pub. No.: US 2025/0051602 A1
(43) Pub. Date: Feb. 13, 2025

(54) DEVICE AND METHOD FOR MAKING SHEAR-ALIGNED, SOLVENT-CAST FILMS

(71) Applicants: Eric R. Gottlieb, Newark, DE (US); Thomas H. Epps, Bear, DE (US)

(72) Inventors: Eric R. Gottlieb, Newark, DE (US); Thomas H. Epps, Bear, DE (US)

(73) Assignee: University of Delaware, Newark, DE (US)

(21) Appl. No.: 18/720,851

(22) PCT Filed: Dec. 16, 2022
(86) PCT No.: PCT/US2022/053212

§ 371 Date: Jun. 17, 2024

Related U.S. Application Data
(60) Provisional application No. 63/290,882, filed on Dec. 17, 2021.

(51) Int. Cl. C09D 153/02; B05D 3/12; B82Y 30/00

(52) U.S. Cl. CPC C09D 153/02; B05D 3/12; B82Y 30/00

(57) ABSTRACT

Disclosed herein is an inline rolling shear alignment (IRSA) coating device and methods of producing a nanostructured film and inorganic nanostructures. The IRSA coating device comprises a coating head for disposing a solvent-containing film having a starting amount of solvent on a substrate; a roller comprising a rigid axle having a pad radially disposed thereon, the pad in contact with the film at a film-roller contact area located a distance from the deposition area; means for causing relative motion between the film and the roller in an operation direction at a film velocity; and a resistance member coupled to the roller, the resistance member configured to apply a rotation-opposing bias to the roller in an amount sufficient to cause the roller to apply a desired amount of shear stress to the film in the film-roller contact area during rotation of the roller.

### CROSS-REFERENCE TO RELATED APPLICATION

This application claims priority to U.S. Provisional Patent Application No. 63/290,882, filed Dec. 17, 2021, the entire disclosure of which is incorporated herein by reference for all purposes.

### STATEMENT REGARDING FEDERALLY SPONSORED RESEARCH

This invention was made with government support under Grant Nos. 70NANB12H302 awarded by the National Institute of Standards and Technology (NIST), DMR-1610134 awarded by the National Science Foundation (NSF), and DE-SC0021166 awarded by the U.S. Department of Energy. The government has certain rights in the invention.

### BACKGROUND OF THE INVENTION

Continuous processes to create periodic, nanostructured arrays with long-range order (i.e., over macroscopic length-scales) have received growing attention because such patterns enable nanotechnologies including nanoporous membranes, nanolithographic masks, and ultradense nanowires. Although nanoscale components can be produced through batch-mode lithographic approaches, the fabrication of small features over large areas becomes cost prohibitive, especially on flexible substrates. One promising, low-cost alternative is to employ block polymers (BPs) as templating agents because they spontaneously assemble into nanoscale features of uniform size and spacing. Indeed, polymeric microphase separation has been exploited to fabricate a wide range of periodic structures, but the resultant patterns tend to contain defects and lack long-range order, which hinders their use in applications like nanowire templating.

BP thin film nanostructures can be oriented with the aid of external stimuli, and as such, a number of methods have been developed to induce alignment, including epitaxial, field-based, or zone-based approaches. Yet, critical drawbacks hinder the commercialization of each of these techniques—in particular, most methods are restricted to batch-mode operation, which limits production throughput.

Epitaxial routes, such as graphoepitaxy or chemoepitaxy, orient BP nanostructures by patterning a surface either through etching, by chemical substrate modification, or with crystal facets. The main factors that direct self-assembly for these methods are confinement and surface interactions, as opposed to externally applied fields. Because lithography often is used for etching or surface modifications, complex patterns can be generated for electronics applications, such as magnetic storage media. However, lithography makes the overall processing slow, expensive, and restricted to small areas in batch operation, which can constrain the applicability of these techniques for uses that require faster production.

Field methods can employ external stimuli such as magnetic fields, electric fields, or shear stress to orient BPs. For magnetic and electric fields, contrast between polymer blocks' magnetic susceptibilities or dielectric permittivities is leveraged to create an increased energetic preference for alignment. However, many field-based approaches only are applicable to a limited number of BP systems and typically require timescales on the order of hours to orient nanostructures. Shear alignment of thin films overcomes some of the issues associated with the above techniques, as it has been shown to work on a range of polymers and over larger areas—it operates by combining a lateral force with either heat or solvent vapor to increase chain mobility. An elastomeric pad (typically crosslinked polydimethylsiloxane, PDMS) on top of the thin film is used to transfer a force produced by manual displacement (“hard shear”) or by solvent swelling followed by deswelling (“soft shear”). Although shear alignment is low cost and has been applied to numerous polymer systems, long processing times and batch operation limit the commercial applicability of this approach.

Zone methods use localized heat or solvent vapor to anneal polymers; and with the addition of a PDMS pad on top of the film, these techniques also can align BP nanostructures via shear. The shear to orient BP nanostructures is generated by localized expansion and contraction of a PDMS pad. Although some of these techniques can be amenable to continuous operation, they operate at relatively slow speeds (˜200 μm/s). Furthermore, polymer compatibility with thermal or photo-thermal zone annealing approaches is limited because the exposure of samples to high temperatures can lead to chemical degradation or undesirable morphological changes.

Hence, there is a need for a device and a rapid, single-step method for aligning block polymer, thin-film nanostructures at speeds higher than conventional techniques.

### SUMMARY OF THE INVENTION

Disclosed herein is a device and a rapid, single-step method for aligning block polymer, thin-film nanostructures that is amenable to continuous speeds≥10 mm/s. This method, termed Inline Rolling Shear Alignment (IRSA), uses a roller, such as a roller with an elastomeric pad coupled with an electric hysteresis brake to shear films before the casting solvent fully evaporates, and it can enable high-throughput, large-area manufacturing of patterns such as nanowire templates. IRSA is adaptable to various polymer systems including homopolymer, diblock, triblock, multiblock, star block, brush, bottle brush, polymer blend, polymer/dopant, polymer composite, and a post-shear annealing step can yield high-quality nanostructures with orientation parameters>0.99 and defect densities as low as 5 defect-pairs/μm². To demonstrate the effectiveness of IRSA, platinum nanowires were produced from this rapid deposition and alignment approach using block polymers such as poly(styrene-b-isoprene-b-styrene), poly(styrene-b-2-vinylpyridine), and poly(styrene-b-ethylene oxide) followed by open-air, atmospheric-pressure plasma etching. This integrated concept, with 50× faster operation than existing processes, could be leveraged for cost-effective manufacturing of macroscopically aligned nanostructures in roll-to-roll systems.

In an aspect of the present invention, there is provided an IRSA coating device comprising:
(i) a coating head for disposing a solvent-containing film having a starting amount of solvent on a substrate in a deposition area;
(ii) a roller comprising a rigid axle having a pad radially disposed thereon, the pad in contact with the film at a film-roller contact area located a distance from the deposition area, wherein there is a desired amount of friction between a portion of a surface of the pad and the film;
(iii) means for causing relative motion between the film and the roller in an operation direction at a film velocity and for causing the roller to rotate in a direction such that the roller in the film-roller contact area has a tangential velocity in the same direction as the film velocity;
(iv) a resistance member coupled to the roller, the resistance member configured to apply a rotation-opposing bias to the roller in an amount sufficient to cause the roller to apply a desired amount of shear stress to the film in the film-roller contact area during rotation of the roller,
wherein the distance between the deposition area and the film-roller contact area is sufficient to permit a predetermined amount of evaporation of the solvent in the solvent-containing film between the deposition area and the film-roller contact area at the film velocity such that the solvent-containing film in the contact area of the film comprises a residual amount of solvent that is less than the starting amount of solvent.

In an embodiment, the device further comprises a resistance member controller for controlling the shear stress that is sufficient to align nanostructures of the film.

In an embodiment of the device, the film comprises homopolymer, block (co) polymer, and blends thereof, and composites comprising a mixture of polymeric and non-polymeric material, wherein the block copolymer comprises a diblock copolymer, a triblock copolymer, a multiblock copolymer, or star block copolymer. Suitable block copolymer include, but are not limited to poly(styrene-b-isoprene-b-styrene) (PS-PI-PS; also commonly referred to as SIS), poly(styrene-b-2-vinyl pyridine) (PS-P2VP), poly(styrene-b-ethylene oxide) (PS-PEO), poly(styrene-b-dimethylsiloxane), and poly(styrene-b-methyl methacrylate).

In another embodiment of the device, the pad is made from a functionalized or non-functionalized elastomeric polymer selected from the group consisting of natural rubber, polyisoprenes, polybutadienes, polychloroprenes, polysiloxanes, fluorosilicones, fluoroelastomers, polypropylene, and polystyrene based elastomeric copolymers and blends.

In yet another embodiment of the device, an amount of shear stress applied to the film at the film-roller contact area is in the range of 1 to 250 kPa.

The resistance member of the device may comprise an external electromagnetic brake, a frictional brake, or an internal resistance.

In an embodiment, the pad comprises a chemically or physically patterned surface.

In another embodiment of the device, the solvent-containing film may comprise a mixture of two or more solvents.

In another aspect, there is a method of producing a nanostructured film, comprising:
(i) providing the IRSA coating device as disclosed hereinabove;
(ii) causing relative motion between the coating head and the substrate, and applying with the coating head on the substrate the solvent-containing film having the starting amount of solvent and a polymeric material for forming the nanostructured film,
(iii) contacting a portion of a surface of a pad radially disposed over the roller to the solvent-containing film in the film-roller contact area at a temperature; and
(iv) applying a sufficient amount of rotation-opposing bias to the roller with the resistance member such that the shear stress applied by the roller to the film in the film-roller contact area during rotation of the roller causes formation of a nanostructured film; and
(v) optionally annealing the nanostructured film.

In an embodiment of the method, the rotation-opposing bias is applied to the roller via an external electromagnetic brake, a frictional brake, or an internal resistance. The method further comprises controlling the shear stress by adjusting one or more of: amount of rotation-opposing bias applied by the brake, overall radius of the roller, and amount of area defined by the film-roller contact area. In an embodiment of the method, the resistance member comprises an electric hysteresis brake, and the amount of shear stress is controlled by adjusting an amount of current applied to the electric hysteresis brake using the resistance member controller.

In another embodiment, the amount of residual solvent in the film-roller contact area is controlled by adjusting the film speed or by adjusting the distance between the film-roller contact area and the coating head.

In an embodiment, the nanostructured film resulting from steps (i)-(iii) may be annealed to form an annealed nanostructured film.

In another aspect, there is a method for forming an inorganic nanostructure comprising the steps of:
(i) using the nanostructured film as disclosed hereinabove as a template for creating an inorganic nanostructure;
(ii) doping the nanostructured film to form an inorganic compound-doped film; and
(iii) etching the inorganic compound-doped film to form the inorganic nanostructure, wherein etching comprises chemical etching, plasma etching, or reactive ion etching.

Any suitable inorganic compound may be used, such as sodium tetrachloroplatinate (II) hydrate or chloroauric acid, sodium tetrachloropalladate, potassium ferricyanide, potassium hexacyanocobaltate (III), copper (II) chloride, nickel (II) chloride, zinc chloride, silicon tetrachloride, or tetraethyl orthosilicate.

In an embodiment of the method, the step of doping may comprise submerging the nanostructured film in a solution of metal compound or doping the nanostructured film by physical vapor deposition, or providing a pre-doped nanostructured film formed by pre-doping the film with the metal compound in the initial casting solution.

In another aspect, there is a method of producing a nanostructured film, comprising the steps of:
a) disposing, with a film applicator, a solvent-containing film on a substrate, the solvent-containing film as disposed having a starting amount of solvent and a polymeric material for forming the hierarchical structure;
b) applying, with a force applicator, a shear stress to the solvent-containing film after first permitting a predetermined amount of evaporation of the solvent in the solvent-containing film between the disposing step and the shear stress applying step, the predetermined amount of evaporation operative to reduce a glass transition temperature of the solvent-containing film below an ambient temperature or to change an otherwise crystalline, semi-crystalline, or glassy material in the solvent-containing film to a deformable amorphous state.

In an embodiment, the method comprises performing the disposing step at a first location and performing the shear stress applying step at a second location spaced a predetermined distance from the first location in a direction of relative movement between the film applicator and the force applicator, and causing relative motion between the film applicator and the force applicator in the direction of relative motion at a relative velocity sufficient to permit the predetermined amount of evaporation of the solvent in the solvent-containing film between the film applicator and the force applicator over the predetermined distance.

### BRIEF DESCRIPTION OF THE DRAWINGS

FIG. 1A displays a schematic illustration of an exemplary IRSA coating device for the IRSA process coupled with flow coating (not shown to scale). The wafer and stage move to the right, and the arrow on the roller indicates the direction of rotation.

FIG. 1B displays a zoomed-in illustration of a portion of the contact area between the pad of the roller and the film. All components are moving to the right, but the roller through pad is transferring a shear stress to the film because of the torque applied by the brake. T refers to torque applied by the brake, and v refers to the velocity of the stage.

FIG. 1C shows another schematic illustration of the device of FIG. 1A with exemplary Atomic force microscopy (AFM) images of a film before and after shear alignment according to embodiments of the present invention.

FIG. 1D shows a photograph of an exemplary experimental setup, according to embodiments of the present invention, with a roller and an electric hysteresis brake mounted in a frame that can move up or down on vertical tracks. Scale bar represents 1 cm.

FIG. 2 shows a photograph of an exemplary polydimethylsiloxane (PDMS) pad on the roller with the (3,3,3,4,4,5,5,6,6-nonafluorohexyl)dimethylchlorosilane-modified (fluorosilane-modified) glass and Teflon as a mold and base, respectively. Scale bar represents 10 mm.

FIG. 3 shows a depth-profile from X-ray photoelectron spectroscopy (XPS) with Arₙ⁺ etching. The plot shows the measured atomic % of Pt incorporated into the PS-P2VP film as a function of etch time. Relative Pt atomic compositions were determined on the basis of photoelectron peak areas, and relative sensitivity factors were provided in the Thermo Scientific Avantage Data System software. The etch rate was ˜3.7 nm/min, and the etch time between local maxima in Pt content corresponded to an etching distance of ˜42 nm, which was similar to the domain spacing of the PS-P2VP. See Table 1 for detailed acquisition parameters.

FIG. 4A shows a representative AFM phase image of an IRSA-sheared poly(styrene-b-isoprene-b-styrene) (PS-PI-PS) thin film (S_{2D} 0.91, 279 defect-pairs/μm²). Scale bar represents 125 nm for the AFM image.

FIGS. 4B and 4C shows grazing incidence small angle X-ray scattering (GISAXS) patterns of an IRSA-sheared film with the X-ray beam (b) parallel and (c) perpendicular to the direction of shear respectively.

FIG. 5 shows (a) a plot of Torque as a function of applied current is shown with black points that correspond to the various film casting conditions. The shear applied during IRSA, shown on the secondary axis, was approximated from the radius and contact area. Note: the direction of the hysteresis is counterclockwise, as indicated by the arrows on the curve. AFM phase images of PS-PI-PS thin films subjected to different shearing conditions: (b) without the roller or shearing (Herman's orientation parameter [S_{2D}] 0.26, 356 defect-pairs/μm²); (c) with the roller, but without the brake connected (S_{2D} 0.04, 539 defect-pairs/μm²); with the brake connected to the roller and the applied current set to (d) 1 mA (S_{2D} 0.77, 438 defect-pairs/μm²), (e) 190 mA (S_{2D} 0.91, 291 defect-pairs/μm²), and (f) 270 mA (S_{2D} 0.94, 205 defect-pairs/μm²). Scale bars represent 125 nm for all AFM images.

FIG. 6 shows (a) Drying curve for 4 wt. % PS-PI-PS in toluene cast at 20 mm/s. The line is the mean from triplicate measures, and the shaded area indicates ±1 standard deviation. Black circles correspond to conditions that were used to cast and shear films by IRSA at 250 mA with differing solvent content. AFM phase images of PS-PI-PS thin films sheared at (b) 5.75 s (S_{2D} 0.66, 493 defect-pairs/μm²), (c) 7.75 s (S_{2D} 0.94, 263 defect-pairs/μm²), and (d) 9.75 s (S_{2D} 0.87, 498 defect-pairs/μm²) between casting and shearing. Scale bars represent 125 nm for all AFM images.

FIGS. 7A-7B shows AFM phase images of an exemplary PS-PI-PS thin film aligned via IRSA with parameters set to generate a film that exhibits weak alignment, (a) FIG. 7A: before (S_{2D} 0.71, 617 defect-pairs/μm²) and (b) FIG. 7B: after solvent vapor annealing (SVA) with chloroform (S_{2D}>0.99, 5 defect-pairs/μm²). Scale bars represent 125 nm for both AFM images.

FIG. 8A shows a schematic representation and FIG. 8B shows a photograph of an open-air dielectric barrier discharge (DBD) plasma reactor used to process the salt-doped films. Scale bar represents 1 cm. FIG. 8C shows a scanning electron microscopy (SEM) image of the nanowires formed from atmospheric-pressure plasma etching for 2 min. Scale bars represent 125 nm for AFM and SEM images.

FIGS. 9A-9C show AFM height images of exemplary IRSA-processed poly(styrene-b-2-vinylpyridine) (PS-P2VP) thin films cast from different solvents (a) tetrahydrofuran (THF), (b) 19:1 w:w THF:toluene, and (c) 9:1 w:w THF:toluene respectively. Scale bar represents 125 nm in all panels.

FIGS. 10A and 10B show AFM height images of exemplary IRSA-processed PS-PEO thin films formed from 1 wt. % solution (a) before and (b) after SVA with toluene and water as solvent vapor mixture at room temperature.

FIG. 11 show an AFM phase image of an exemplary IRSA-processed thin film of a composite, PS-PEO with Zn acetate with a 10:1 PEO monomer: Zn acetate stoichiometric ratio, cast from 9:1 by weight of toluene:methanol as solvent mixture.

FIG. 12 show an AFM phase image of an exemplary IRSA-processed thin film of blend of PS-PI-PS:PS 9:1 by weight cast from toluene as a solvent.

### DETAILED DESCRIPTION OF THE INVENTION

As used herein, the term “solvent” refers to a material for dissolving or suspending a polymer or other material for casting into a film, and which evaporates during subsequent processing to form the desired film having a nanostructure. For example, the solvent may be water, an organic solvent, or any combination thereof. Exemplary organic solvents include toluene, any one or more of the three xylene isomers (ortho, meta, or para), tetrahydrofuran (THF), chloroform, methanol, ethanol, isopropanol, n-hexane, cyclohexane hexanol, ethyl acetate, ethyl ether, methyl ethyl ketone, propylene glycol methyl ether acetate, and blends thereof. Exemplary nanostructures made using the coating heads and methods of the invention can be made from materials such as polymers, polymer blends, block copolymers (BP), composites comprising a mixture of polymeric and non-polymeric material, nanocomposites, fibers, biological materials, proteins, nanoparticles, nanotubes, and nanowires. As used herein, the block copolymer may comprise a diblock copolymer, a triblock copolymer, a multiblock copolymer, or a star block copolymer.

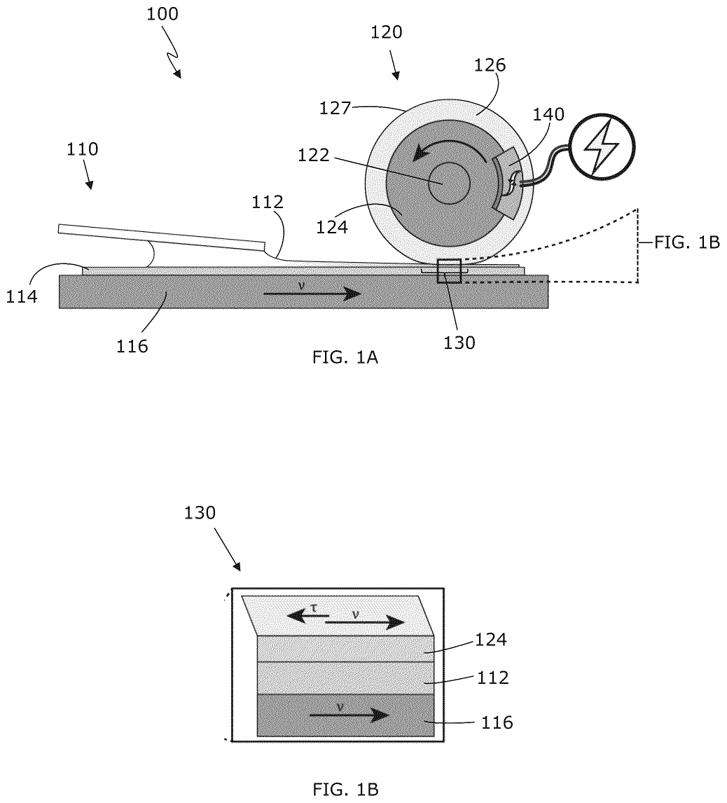

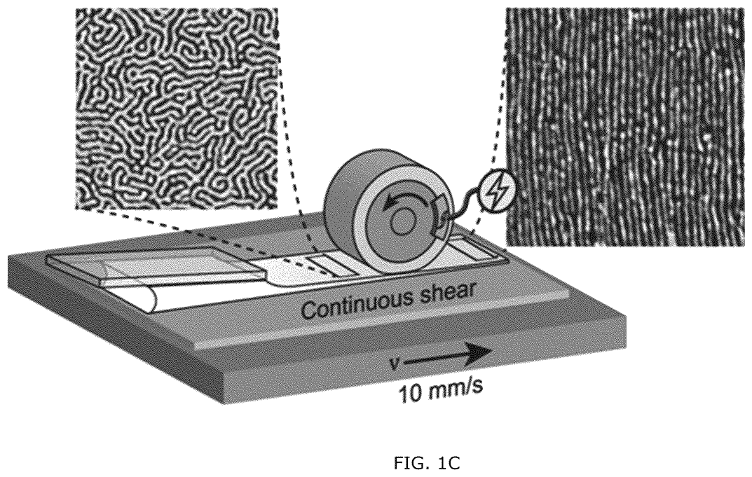

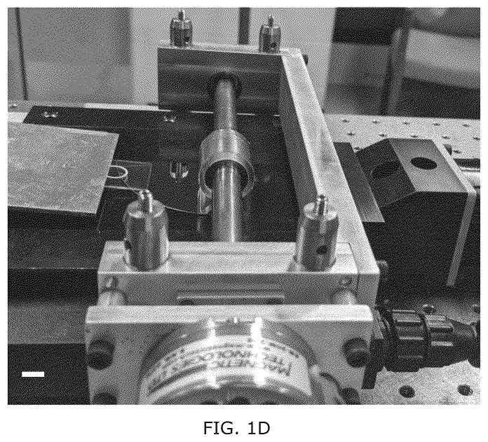

The present invention discloses a new, single-step, shear-based, rapid process that deposits and aligns BP thin-film nanostructures over macroscopic areas and is amenable to continuous or roll-to-roll processing. This method, termed Inline Rolling Shear Alignment (IRSA), uses a PDMS roller to shear polymer thin films before the solvent from the solution has fully evaporated (FIG. 1A). As discussed hereinbelow, in some embodiments of the inventive IRSA coating device and the inventive methods, one can achieve BP alignment factors greater than 0.99, along with the utility of the IRSA approach to create aligned arrays of platinum nanowires efficiently from a flow-coated BP template. For the IRSA system, a roller rotates as the freshly coated substrate moves, and the roller pad provides shear stress in the form of static friction at the film-roller contact area between a portion of a surface of the pad and the film and the film in the opposite direction to the overall system velocity. In an embodiment, the roller is held in a frame with two ball bearings that allow it to rotate with limited resistance, and the additional resistance necessary to induce alignment is produced by an electric hysteresis brake coupled to the roller's axle shaft. The electric hysteresis brake uses an electromagnet to generate a drag torque that controls rolling resistance, which uniquely enables tunability of the shear stress applied to the film. A zoomed-in illustration of the location where the roller and film interact is shown in FIG. 1B, with arrows indicating the direction of motion and the direction of the applied torque. FIG. 1D includes a photograph of an exemplary experimental setup according to embodiments of the present invention.

There are two key aspects that differentiate IRSA coating device of the present invention from conventional shear-alignment devices and methods: (1) the shear imparting member or a force applicator is a roller as opposed to a flat pad; and (2) the shear stress is applied to a film with residual solvent from casting, instead of a heated or solvent vapor swollen film. The result is an integrated process that is relatively fast (i.e., ˜10 mm/s in comparison to 200 μm/s), robust, simple, inexpensive, minimizes solvent waste, and is amenable to continuous processing.

Disclosed herein is an exemplary procedure for IRSA and a resulting thin-film nanostructure are presented. Also, disclosed herein is the effect of shear strength and solvent content on alignment is discussed with poly(styrene-b-isoprene-b-styrene) (PS-PI-PS) as a model system. Also, the effectiveness of post-IRSA annealing is shown, with high-quality nanostructures that exhibit orientation parameters>0.99 and defect densities as low as 5 defect-pairs/μm². Additionally, an application of IRSA is demonstrated for the fabrication of highly oriented platinum nanowires from a poly(styrene-b-2-vinyl pyridine) (PS-P2VP) template in a process that is fully compatible with continuous operation by using open-air atmospheric-pressure plasma to etch the polymer. This result highlights the applicability of the method for high-throughput production of inorganic patterns, which may help to enable commercialization of many large-area nanostructured systems.

### IRSA Coating Device

FIG. 1A shows a schematic illustration of an exemplary IRSA coating device 100 according to embodiments of the present inventions. The IRSA coating device 100 comprises a coating head 110 for disposing a solvent-containing film 112 having a starting amount of solvent on a substrate 114 in a deposition area; a roller 120 comprising a rigid axle 122 disposed through an optional roller body 124 and having a roller pad 126 radially disposed thereon, the roller pad 126 in contact with the film 112 at a film-roller contact area 130 located a distance d from the deposition area, such that there is a desired amount of friction between a portion of a surface 127 of the pad 126 of the roller 120 and the solvent-containing film 112. The IRSA coating device 100 also comprises means for causing relative motion between the film 112 and the roller 120 in an operation direction at a film velocity v and for causing the roller 120 to rotate in a direction such that the roller 120 in the film-roller contact area 130 has a tangential velocity in the same direction as the film velocity. Exemplary means for causing relative motion, without limitation thereto, may include a moveable stage or conveyor belt on which the film is disposed and which has a drive for causing the stage or belt to move relative to a fixed roller, a carriage or gantry to which the roller is affixed and which has a drive for causing the carriage or gantry to move relative to a fixed substrate on which the film is disposed, a stationary stage with tension applied to the film on a flexible substrate during winding in a roll to roll process thereby causing a relative motion between the film and the roller, or some combination thereof. Drive mechanisms for such stages, conveyors, gantries, and carriages are well known in the art and not described in detail herein.

The IRSA coating device 100 further includes a resistance member 140 coupled to the roller 120, the resistance member 140 is configured to apply a rotation-opposing bias to the roller 120 in an amount sufficient to cause the roller 120 to apply a desired amount of shear stress T to the film 112 in the film-roller contact area 130 during rotation of the roller 120. The distance between the deposition area and the film-roller contact area 130 is sufficient to permit a predetermined amount of evaporation of the solvent in the solvent-containing film 112 between the deposition area and the film-roller contact area 130 at the film velocity such that the solvent-containing film in the contact area 130 of the film 112 comprises a residual amount of solvent that is less than the starting amount of solvent. In an embodiment, the substrate 114 is disposed over a moving stage 116. In another embodiment, the stage 116 is stationary and the substrate 114 is moving as in a roll-to-roll process.

The surface 127 of the roller 120 may be smooth, chemically, or physically patterned. Nonlimiting examples of patterns include patterns of dimples or bumps, or patterns of raised lines and/or channels, which may run transversely, or in the direction of draw, or diagonally.

Any suitable material may be used for the pad 124 of the roller 120, as long as there is there is a desired amount of friction between a portion of a surface 127 of the pad 126 and the film 112. The pad 126 may be made from any of a variety of materials, including for example flexible metals, acrylics, natural or synthetic rubbers, fibers (or fiber mats), fluoropolymers, elastomers (including thermoplastic elastomers), depending on the desired film composition. Specific examples include functionalized or non-functionalized polymers selected from the group consisting of natural rubber, polyisoprenes, polybutadienes, polychloroprenes, polysiloxanes, fluorosilicones, fluoroelastomers, polypropylene, and polystyrene based elastomeric copolymers and blends.

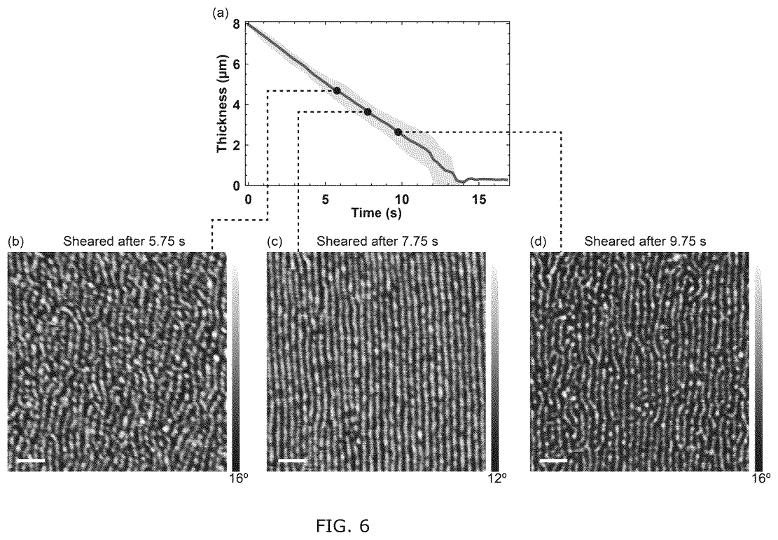

The distance between the deposition area and the film-roller contact area 130 may be adjustable, with the distance controlling how much solvent evaporates between the deposition area and the film-roller contact area 130 and therefore how much is still present in the film at the film-roller contact area 130 during shear-alignment. The distance is adjusted to permit a predetermined amount of evaporation of the solvent in the solvent-containing film between the deposition area and the film-roller contact area at the film velocity such that the solvent-containing film in the contact area of the film comprises a residual amount of solvent that is less than the starting amount of solvent. When there is an optimal amount of solvent remaining in the film 112 at the film-roller contact area 130, the shear imparted by the roller 120 effects directional alignment, as shown in FIG. 6, discussed infra in details. Appropriate amounts of solvent are those that reduce the glass transition temperature to below the operating temperature or change an otherwise crystalline, semi-crystalline, or glassy material in the solvent-containing film to a deformable amorphous state, thus providing the material with enough molecular mobility to restructure and align, yet the film is still dry enough to avoid being spread by the roller or otherwise damaged. Depending on the composition of the solvent/material mixture, the amount of solvent in the film 112 during shear-alignment can be controlled by adjusting the distance between the deposition area and the film-roller contact area 130. The distance between the deposition area and the film-roller contact area 130 is dependent upon various factures, including, but not limited to the volatility of the solvent in the solvent-containing film, operating temperature, and viscosity of the solvent-containing film at the film-roller contact area. This distance will typically be at least 0.5 cm, or at least 1, 1.5, 2, 2.5, 3, 5, 6, 7, 8, 9, or 10 cm. The distance will typically be at most 50 cm, or at most 40, 30, 20, or 10 cm. In an embodiment, the distance is in the range of 0.5 to 50 cm or 5 to 40 cm or 8 to 38 cm.

Any suitable concentration of the homopolymer, block copolymer, polymer blend, and polymer composite in a solvent may be used in a coating solution. The starting polymer concentration in a coating solution for use in the coating head for depositing a solvent-containing film may be at least 0.1 wt. %, 1 wt. %, or at least 2, 3, 4, 5, 6, 7, 8, 9, or 10 wt. %. It will typically be at most 20 wt. %, or at most 18, 15, 12, 10, 9, or 8 wt. %. In an embodiment, the starting solution concentration may be in the range of 0.1 to 20 wt. %, or 1 to 15 wt. %, or 1 to 8 wt. %. In an embodiment, the polymer concentration in the solvent-containing film 112 at the film-roller contact area 130 may be in the range of 10 to 90 wt. %, or 15 to 80 wt. % or 20 to 75 wt. %.

Any suitable solvent or a mixture of solvents compatible with the homopolymer, block copolymer, polymer blend, and polymer composite may be used. Exemplary solvents include, but are not limited to, include toluene, any one or more of the three xylene isomers (ortho, meta, or para), tetrahydrofuran (THF), chloroform, methanol, ethanol, isopropanol, n-hexane, cyclohexane hexanol, ethyl acetate, ethyl ether, methyl ethyl ketone, propylene glycol methyl ether acetate, and blends thereof. Exemplary solvent mixtures/blends include, but are not limited to a blend of THF and toluene, a blend of touene and methanol, and a blend of toluene, methanol and propylene glycol methyl ether acetate.

The resistance member 140 may be an external electromagnetic brake, a frictional brake, or an internal resistance. The IRSA coating device 100 may also include a resistance member controller (not shown) for controlling the shear stress that is sufficient to align nanostructures of the film.

In an embodiment of the present invention for the exemplary IRSA coating device shown schematically in FIGS. 1A and 1C, shear stress was calculated as follows:

Shear Stress=torque/(radius*contact area)
where torque was determined from factory calibration, radius and length components of contact area were measured from the mold dimensions, and width was measured with a ruler.

Any suitable shear stress may be applied. The shear stress may be at least 0.1, 0.5, 1, 5, 10, 20, 30, 50, 75, 80, 85, 90, or 95 kPa and less than or equal to, 300, 250, or 200, 175, 165, 150, 125, 100, 50, 25, 10, 5, or 2. In an embodiment, shear stress is in the range of 0.1 to 300 kPa, or 1 to 250 kPa, or 10 to 200 kPa, or 25 to 175 kPa, or 50 to 100 kPa.

FIG. 1C shows the schematic illustration of the IRSA coating device of FIG. 1A with exemplary Atomic force microscopy (AFM) images of a film before and after shear alignment.

In an embodiment, the nanostructured film has an orientation parameter of greater than 0.50, 0.70, 0.80, 0.85, 0.90, 0.95, or 0.99. In another embodiment, the nanostructured film has less than 1000, 900, 800, 700, 650, 600, 550, 500, 450, 400, 350, 300, 200, 100, 50, 30, 20, 15, 10, 7, or 5 defect-pairs/μm².

### Method of Producing a Nanostructured Film

Disclosed herein is a method of producing a nanostructured film. The method comprises providing the IRSA coating device according to various embodiments of the present invention; causing relative motion between the coating head and the substrate, and applying with the coating head on the substrate the solvent-containing film having the starting amount of solvent and a polymeric material for forming the nanostructured film. The method also includes contacting a portion of a surface of a pad radially disposed over the roller to the solvent-containing film in the film-roller contact area at a temperature; and applying a sufficient amount of rotation-opposing bias to the roller with the resistance member such that the shear stress applied by the roller to the film in the film-roller contact area during rotation of the roller causes formation of a nanostructured film. The method may further include optionally annealing the nanostructured film.

The method further comprises controlling the shear stress by adjusting one or more of: amount of rotation-opposing bias applied by the brake, overall radius of the roller, and amount of area defined by the film-roller contact area. In an embodiment, the rotation-opposing bias is applied to the roller via an external electromagnetic brake, a frictional brake, or an internal resistance. In another embodiment, the resistance member comprises an electric hysteresis brake, and the method comprises adjusting the shear stress by adjusting an amount of current applied to the electric hysteresis brake using the resistance member controller.

As discussed hereinabove, the amount of residual solvent in the film-roller contact area can be adjusted by adjusting the film speed or by adjusting the distance between the film-roller contact area and the coating head.

In some embodiments, the method may further include annealing the nanostructured film to form an annealed nanostructured film.

In another aspect, there is a method of producing a nanostructured film. The method comprises the steps of disposing, with a film applicator, a solvent-containing film on a substrate, the solvent-containing film as disposed having a starting amount of solvent and a polymeric material for forming the hierarchical structure; and applying, with a force applicator, a shear stress to the solvent-containing film after first permitting a predetermined amount of evaporation of the solvent in the solvent-containing film between the disposing step and the shear stress applying step, the predetermined amount of evaporation operative to reduce a glass transition temperature of the solvent-containing film below an ambient temperature or to change an otherwise crystalline, semi-crystalline or glassy material in the solvent-containing film to a deformable amorphous state.

In an embodiment, the method further comprises performing the disposing step at a first location and performing the shear stress applying step at a second location spaced a predetermined distance from the first location in a direction of relative movement between the film applicator and the force applicator, and causing relative motion between the film applicator and the force applicator in the direction of relative motion at a relative velocity sufficient to permit the predetermined amount of evaporation of the solvent in the solvent-containing film between the film applicator and the force applicator over the predetermined distance.

### Method for Forming an Inorganic Nanostructure

In an aspect of the invention, there is a method for forming a inorganic nanostructure comprising using the nanostructured film, as disclosed hereinabove, as a template for creating a inorganic nanostructure, doping the nanostructured film to form a inorganic compound-doped film, and etching the inorganic compound-doped film to form the inorganic nanostructure, wherein etching comprises chemical etching, plasma etching, or reactive ion etching.

Any suitable inorganic compound may be used, including, but not limited to sodium tetrachloroplatinate (II) hydrate or chloroauric acid, sodium tetrachloropalladate, potassium ferricyanide, potassium hexacyanocobaltate (III), copper (II) chloride, nickel (II) chloride, zinc chloride, silicon tetrachloride, or tetraethyl orthosilicate.

In an embodiment, the step of doping comprises submerging the nanostructured film in a solution of inorganic compound or doping the nanostructured film by physical vapor deposition (PVD). In an embodiment, the step of doping further comprises subjecting the solution containing an inorganic compound to further processing as needed to cause formation of a corresponding salt for doping the film by submerging or doping the nanostructured film by PVD. Further processing may include, for example, adding a base to a metal acid, adding an acid to a metal alkali, heating a metal hydrate, or the like. In another embodiment, the step of doping comprises providing a pre-doped nanostructured film formed by pre-doping the film with the inorganic compound in the initial casting solution.

### Applications of IRSA Thin Films

Potential applications that may benefit from the invention are those that require nanoscale (5-100 nm) features with highly aligned domains. For example, BCP thin films made with a coating head according to the invention are ideally suited for nanolithography, nanotemplating, optical waveguides, optoelectronic devices, patterned media, biological arrays, and organic solar cells. Because the inventive technique allows a high volume, roll-to-roll method to direct alignment, the industrial feasibility of incorporating BCP thin films in the production of these applications improves greatly. The coating head and approach can be applied to a variety of polymer architectures (e.g., homopolymer, diblock, triblock, multiblock, star block, brush, bottle brush, polymer blend, polymer/dopant, polymer composite), polymer properties (e.g., glassy-glassy, glassy-rubbery, high/low Tg, high/low χ, crystalline/non-crystalline), and polymer morphologies (e.g., spheres, lamellae, cylinders, perforated lamellae, and networks).

The inventive coating head and method are desirable for areas of interest and applications including, but not limited to, nanotechnology, nanolithographic masks, nanotemplating, nanoporous membranes, optical waveguides, optoelectronic devices, patterned media, biological arrays, organic solar cells, energy transportation and storage, water purification, gas separations, insulation, mechanical durability, medicine, clothing, optical coatings, computer processors, radiation shielding, surface coatings, contact lenses, wearable electronics, lubricants, hydrophobic coatings, hydrophilic coatings, oleophobic coatings, cookware coatings, sensors, analytical instruments, heating/cooling devices, microfluidic devices, aerospace parts, nylons, chemical processing, naval equipment, automotive technology, wireless communication, memory storage, biological implants, actuators, pace makers, window coverings, cell phones, music devices, pH sensors, and polymer grafting.

Possible additional applications for the inventive coating head are plentiful as it is amenable to widely used industrial processing techniques. Additionally, the shear used to align structures in the film can be adjusted to align both hard (e.g., fibers, nanoparticles, nanotubes) and soft (e.g., polymers, biological materials, proteins) materials. Other areas of interest and potential application are included, but not limited to, energy transportation, battery and fuel cell parts, medical stents, cosmetics, personal health and beauty, food storage and processing, pharmaceuticals, housing, fiber production, bulletproof vests, aircraft equipment and parts, medical equipment casing, skin grafts, optical coatings, electronic casings, sporting equipment, self-healing materials, clothing, lubricants, biomedical devices, electronic coatings, microdots, protective gear, Kevlar production, abrasion-resistant materials, heat shields, harsh weather/environment electronics, liquid films, and polarization, liquid-crystal polymers, musical equipment/instruments, thermal properties, mechanical tuning, electrical conductivity, fiber optics, nanowires, and plumbing.

As used herein, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

### EXAMPLES

Examples of the present invention will now be described. The technical scope of the present invention is not limited to the examples described below.

### Abbreviations

AFM=atomic force microscopy
BP=block polymer
DBD=dielectric barrier discharge
fluorosilane=(3,3,3,4,4,5,5,6,6-nonafluorohexyl)dimethylchlorosilane
GISAXS=grazing incidence small angle X-ray scattering
IRSA=Inline Rolling Shear Alignment
PDMS=polydimethylsiloxane
PS-P2VP=poly(styrene-b-2-vinylpyridine)
PS-PI-PS=poly(styrene-b-isoprene-b-styrene)
S_{2D}=Herman's orientation parameter
SEM=scanning electron microscopy
SVA=solvent vapor annealing
THF=tetrahydrofuran
XPS=X-ray photoelectron spectroscopy.

### Materials

PS-PI-PS was obtained from DEXCO (V4211) and used as received. The PS-PI-PS polymer had an overall molecular weight of 118 kg mol⁻¹ and dispersity of 1.09 [size exclusion chromatography (Viscotek, GPCmax WE-2001)], volume compositions for each block of f_{S}=0.134, f_{I}=0.732, and f_{S}=0.134 [proton nuclear magnetic resonance spectroscopy (Bruker, AVX400)], domain spacing of 33 nm, and a cylindrical nanostructure as characterized by small-angle X-ray scattering and atomic force microscopy (AFM). PS-P2VP obtained from Polymer Source and used as received. The PS-P2VP polymer had a number average molecular weight of 62.5 kg mol⁻¹, dispersity of 1.07, volume compositions for each block of f_{S}=0.72 and f_{P2VP}=0.28, domain spacing of 40 nm, and cylindrical nanostructure as assessed using the techniques described above. Chloroform, tetrahydrofuran (THF), and toluene (ACS grade) were obtained from Sigma-Aldrich and used as received. All polymer solutions were stirred for at least 3 h and filtered through 0.2 μm syringe filters prior to use.

### Methods

### Elastomeric Roller Fabrication

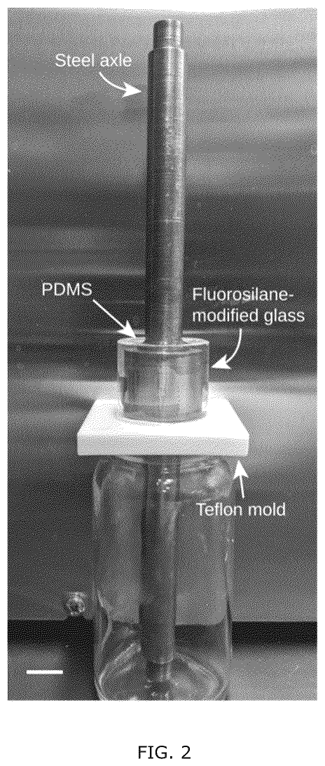

The mold for casting the polydimethylsiloxane (PDMS) roller consisted of a steel axle, a borosilicate glass tube, and a Teflon base. To minimize adhesion between the PDMS and the borosilicate glass tube, the surface of the glass was modified by the addition of a fluorochlorosilane monolayer. A cylindrical glass tube was used as a mold for making a roller with an elastomeric PDMS pad and an axle. The glass tube was first rinsed with toluene and cleaned in an ultraviolet ozone cleaner (model 342, Jelight Co., Inc.) for 2 hours, then surface modified by (3,3,3,4,4,5,5,6,6-nonafluorohexyl)dimethylchlorosilane (fluorochlorosilane, Gelest Inc., used as received) via vacuum deposition for 5 h. After chlorosilane deposition, the glass tube was rinsed with toluene to remove unreacted chlorosilane and dried with compressed nitrogen gas (Keen Compressed Gas). The elastomeric pad on the roller was generated from a PDMS kit (Dow Corning Sylgard 184) at a 10:1 w:w ratio of elastomer base to curing agent. The mixture was degassed under dynamic vacuum for 1 h, poured into the mold (FIG. 2), and cured at 70° C. for 15 h. After curing and subsequent cooling to room temperature, the roller was removed gently from the mold, rinsed with toluene, and dried for at least 1 h in air before use. The roller was mounted into a custom-built metal frame and held in place by ball bearings. The axle of the roller was interfaced to an electric hysteresis brake (Magnetictech EB20M-2DS) by a D-shaft connected to a D-shaft coupler. The electric hysteresis brake was connected to a constant current power supply (Magnetictech PowerPro 24) to control torque.

### Characterization

### Atomic Force Microscopy (AFM):

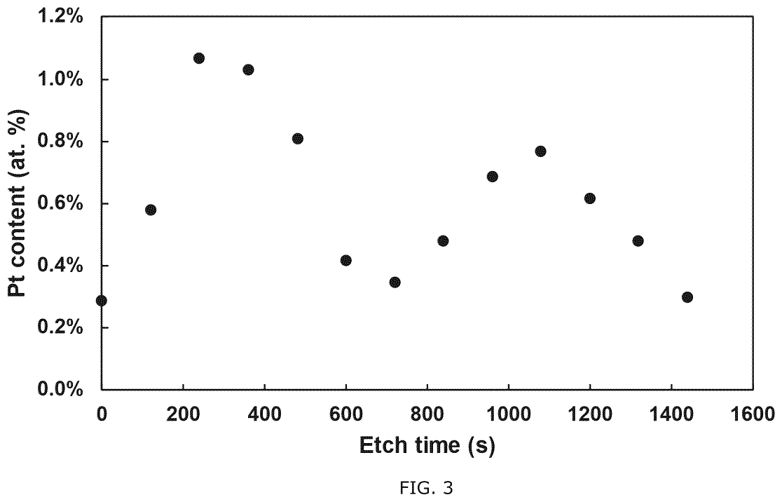

AFM phase images were obtained on a Bruker Veeco Dimension 3100 with Nanoscope V controller operating in tapping mode using Budget Sensors TAP150-G tips (150 kHz, 5 Nm⁻¹) and at a typical set point ratio of 0.65. All AFM phase images were processed with Gwyddion (version 2.55) with second-order polynomial, row-by-row alignment. Nanostructure quantification was performed using ImageJ (version 1.52i) and the macro ADAblock for ImageJ available at Github repository (Jeffrey N Murphy (2015), ADAblock: Automated Defect Analysis for Block Copolymers Version 1.0 (v1.0.0). Zenodo. doi.org/10.5281/zenodo.19644), written for the analysis of defects in line patterns produced from the domains of block copolymer thin films. Scanning electron microscopy (SEM) images were obtained using an Auriga 60 CrossBeam. Samples were placed on double-sided carbon tape, and images were taken using an accelerating voltage of 3 kV at a nominal working distance of 10 mm. All AFM and SEM images were collected towards the center of the films, and edge effects on alignment were not assessed because the design of the system allows for a roller to be fabricated with sufficient width to ensure the entire area of interest is sheared. Grazing incidence small-angle X-ray scattering (GISAXS) patterns were obtained using a Xenocs Xeuss 2.0 with a Cu source (λ=0.154 nm) and a Pilatus 300K pixel array detector (pixel size 172 μm) with 12 h acquisition times. Samples were placed in a vacuum chamber and positioned with an incident angle in the range of 0.1°-0.2°. X-ray photoelectron spectroscopy (XPS) was conducted using a Thermo Fisher K-Alpha+XPS with a micro-focused monochromator Al source (1486.6 eV, spot size 200 μm). Depth profiling was performed with an EX06 ion gun and Arₙ⁺ clusters (8000 eV, 4 mm×2 mm area, 35° angle of incidence). The takeoff angle between the sample surface and the analyzer was 90°, and survey, Pt4f, and C1s spectra were collected. Detailed XPS acquisition parameters are listed in Table 1. Sputtering occurred at 2 min intervals. An average etching rate of 3.7 nm/min was determined by sputtering a sample (thickness of 100 nm, measured with a spectral reflectometer, Filmetrics, F20-UV) until an Si2p peak was obtained in the survey spectrum. Pt atomic composition was determined on the basis of signal peak areas and relative sensitivity factors from the Thermo Scientific Avantage Data System software. All peaks were background subtracted with the Thermo Scientific Avantage Data System Smart background and charge corrected so that the carbon-carbon C1s bond peak maximum position had a binding energy of 284.8 eV. Spectra peaks were analyzed using Thermo Scientific Avantage Data System software. Relative Pt atomic compositions were determined on the basis of photoelectron peak areas, and relative sensitivity factors were provided in the Thermo Scientific Avantage Data System software. See FIG. 3 for Pt content as a function of etch time.

TABLE 1
Detailed X-ray photoelectron spectroscopy
(XPS) acquisition parameters.

| Acquisition type | Binding energy | Pass energy | Data spacing | |
|---|---|---|---|---|
| or element | (eV) | (eV) | (eV) | Sweeps |
| Survey | (−10)-1350 | 100 | 1 | 2 |
| Pt 4f | 66-84 | 20 | 0.2 | 5 |
| C 1s | 278-298 | 20 | 0.2 | 5 |

### Solvent Vapor Annealing (SVA):

For the annealing study, SVA was used as follows. The film was placed in a chamber with a quartz top and an inlet and outlet for controlling solvent vapor flow. A mass flow controller (MKS Instruments Type 146C Cluster Gauge) was used to bubble nitrogen gas at a flowrate of 20 mL/min through a chloroform-containing reservoir to produce a solvent-rich vapor stream. The thickness of the film was tracked with a spectral reflectometer, and measurements were taken every minute for the duration of annealing. When the film was swollen to 40% from its initial thickness, the inlet and outlet of the chamber were closed, and the film underwent a ‘static’ anneal for 2 h. Then, the cover was opened, removing all solvent vapor, thereby instantly (<10 s) deswelling the film.

### Drying Curve (FIG. 6):

A 4 wt. % PS-PI-PS in toluene solution was cast in triplicate at 20 mm/s. Spectral reflectance measurements of films from the initial casting event through the drying process were obtained by attaching the probe of the reflectometer to the stage used for casting. Data points were collected every 0.25 s with an integration time of 10 ms until the thickness measurements did not change significantly (+5%), indicating that the film was nominally dry.

### Example 1: Thin Film Casting and Shearing by IRSA

Prior to casting, silicon wafers (<100> orientation, Wafer World) were triple rinsed with toluene, dried with compressed nitrogen gas, processed in an ultraviolet ozone cleaner for 1 h, and re-rinsed with toluene. All thin films were cast onto a cleaned wafer. The cleaned wafer was affixed to the stage using clear tape, and a glass casting blade was positioned ˜200 μm above the wafer. 25 μL of polymer solution was dispensed between the blade and wafer. When the films were sheared by IRSA, the roller assembly was mounted onto vertical tracks prior to film casting, and a constant-current power supply was set to a predetermined value. See Table 2 below for all conditions used to produce each film. All PS-PI-PS films (Sample Nos. 1, 2A-2D, 3A-3C, and 4) used in these studies were ˜120 nm thick; PS-P2VP film (Sample Nos. 5-6) was ˜100 nm thick; PS film (Sample No. 7) was ˜120 nm thick; PS-PEO film (Sample Nos. 8 and 9) was ˜85 nm thick; PS-PI-PS film (Sample No. 10) was ˜120 nm thick; and PS-PI-PS film (Sample No. 11) was destroyed and film thickness could not be measured.

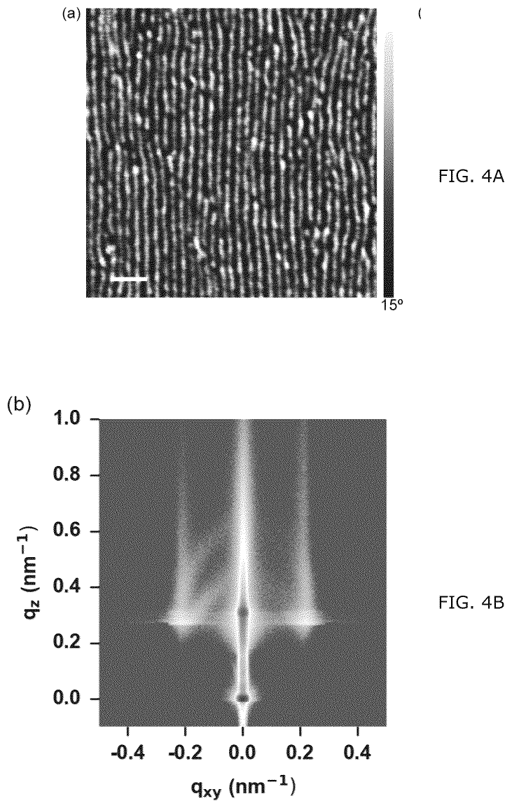

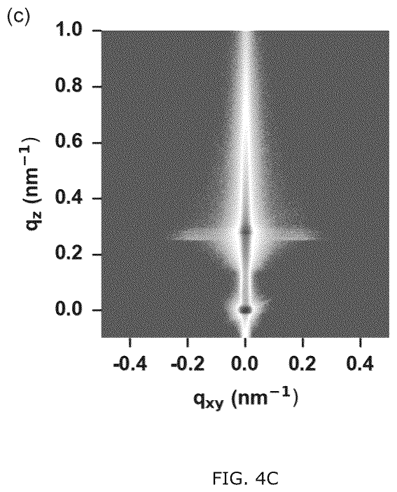

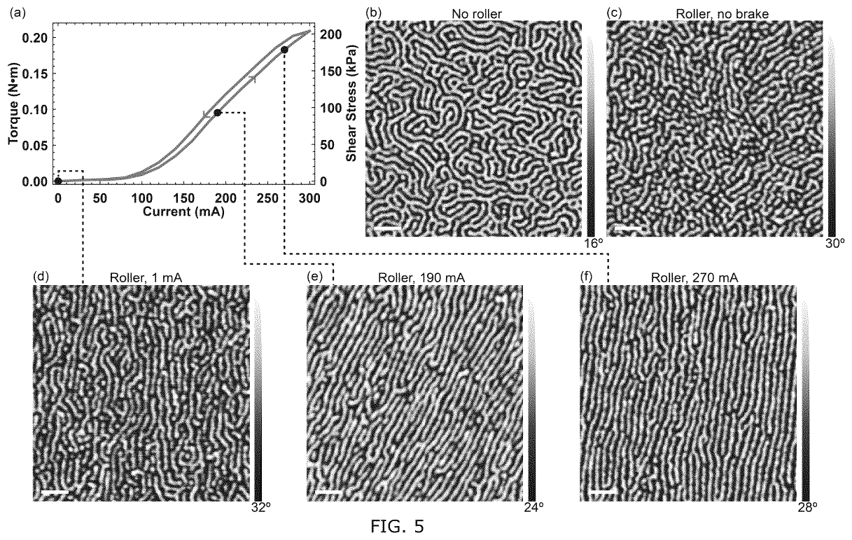

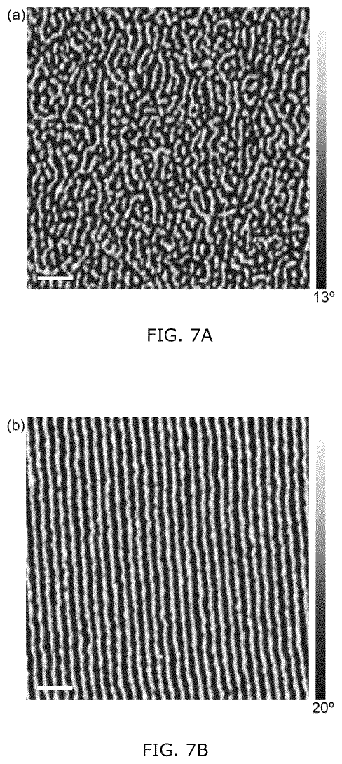

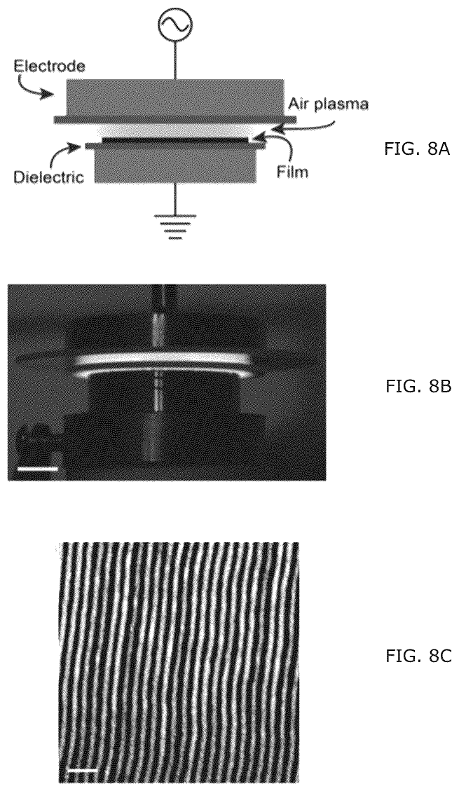

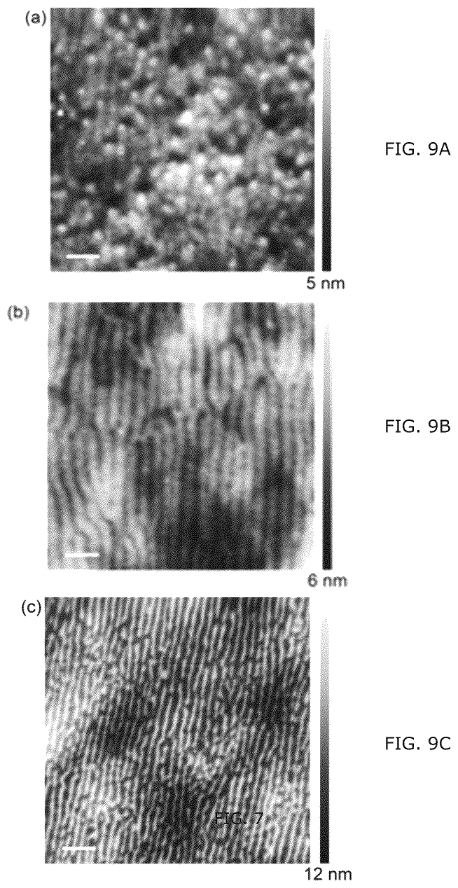

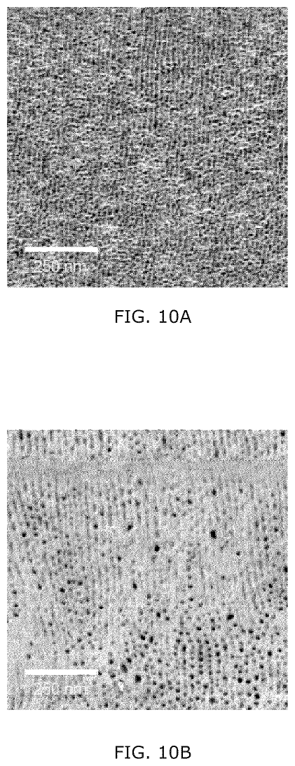

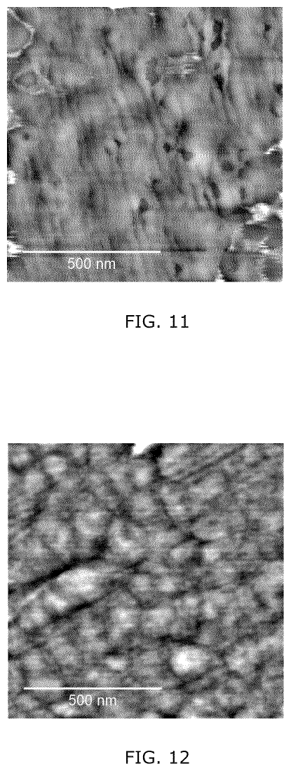

TABLE 2
Conditions used to cast and shear films with IRSA.

| | Sample | | | Solution | | Casting | | Applied | | Shear |
|---|---|---|---|---|---|---|---|---|---|---|
| Sample | shown in | | | concentration | Blade-to-roller | speed | Pause time | current | Torque | stress |
| No. | FIG. | Polymer | Solvent | (wt. %) | distance (mm) | (mm/s) | (s) | (mA) | (N · m) | (kPa) |
| 1 | FIG. 4a | PS-PI-PS | Toluene | 4 | 35 | 20 | 6 | 250 | 0.162 | 159 |
| 2A | FIG. 5b | PS-PI-PS | Toluene | 4 | N/A | 10 | N/A | N/A | — | — |
| 2B | FIG. 5c | PS-PI-PS | Toluene | 4 | 35 | 10 | 0 | N/A | — | — |
| 2C | FIG. 5d | PS-PI-PS | Toluene | 4 | 35 | 10 | 0 | 1 | 0.001 | 1 |
| 2D | FIG. 5e | PS-PI-PS | Toluene | 4 | 35 | 10 | 0 | 190 | 0.095 | 93 |
| 2F | FIG. 5f | PS-PI-PS | Toluene | 4 | 35 | 10 | 0 | 270 | 0.183 | 180 |
| 3A | FIG. 6b | PS-PI-PS | Toluene | 4 | 35 | 20 | 4 | 250 | 0.162 | 159 |
| 3B | FIG. 6c | PS-PI-PS | Toluene | 4 | 35 | 20 | 6 | 250 | 0.162 | 159 |
| 3C | FIG. 6d | PS-PI-PS | Toluene | 4 | 35 | 20 | 8 | 250 | 0.162 | 159 |
| 4 | FIGS. 7a-7b | PS-PI-PS | Toluene | 4 | 35 | 10 | 2 | 250 | 0.162 | 159 |
| 5 | FIG. 8c | PS-P2VP | 19:1 w:w | 3 | 10 | 15 | 0 | 250 | 0.162 | 159 |
| | | | THF:toluene | | | | | | | |
| 6A | FIG. 9A | PS-P2VP | THF | 3 | 10 | 10 | 0 | 250 | 0.162 | 159 |
| 6B | FIG. 9B | PS-P2VP | 19:1 w:w | 3 | 10 | 10 | 0 | 250 | 0.162 | 159 |
| | | | THF:toluene | | | | | | | |
| 6C | FIG. 9C | PS-P2VP | 9:1 w:w | 3 | 10 | 10 | 0 | 250 | 0.162 | 159 |
| | | | THF:toluene | | | | | | | |
| 7 | — | PS | Toluene | 2 | 35 | 20 | 4 | 250 | 0.162 | 159 |
| 8A | FIG. 10A- | PS-PEO | Toluene | 1 | 35 | 30 | 2 | 250 | 0.162 | 159 |
| | 10B | | | | | | | | | |
| 8B | — | PS-PEO | Toluene | 2 | 35 | 10 | 1 | 250 | 0.162 | 159 |
| 9 | FIG. 11 | PS-PEO with | 9:1 | 2 | 35 | 20 | 4 | 250 | 0.162 | 159 |
| | | Zn Acetate | toluene:methanol | | | | | | | |
| 10 | FIG. 12 | 9:1 w:w PS-PI- | Toluene | 2 | 35 | 20 | 4 | 250 | 0.162 | 159 |
| | | PS:PS | | | | | | | | |
| 11 | — | PS-PI-PS | Toluene | 4 | 35 | 20 | 6 | 250 | 0.162 | 159 |

In a typical experiment, a polymer solution of Sample Nos. 1-11 was flow coated onto a UV-ozone-cleaned silicon wafer. A PDMS roller, installed at a predetermined distance from the casting blade, then was pressed down onto the wafer. The movement of the substrate was controlled by a programmable, motorized stage with a set velocity. The stage could be optionally paused after flow coating to allow more solvent to evaporate before the film was sheared by the roller. An electric hysteresis brake connected to the roller's axle was controlled by a constant-current digital power supply that was set to a predetermined current to target a desired output torque. The nanostructures then were assessed by AFM. To provide a basis for relative comparisons of nanostructure quality, a Herman's orientation parameter (S_{2D}) and defect density for each image was calculated with ImageJ and the macro ADAblock. Table 3 provides the values from all PS-PI-PS films imaged herein). S_{2D} values can range from 0 and 1, with 0 representing no directionality, and 1 indicating perfect alignment. For example, FIG. 4A contains an AFM phase image of PS-PI-PS films flow coated from 4 wt. % in toluene at 20 mm/s and paused for 6 s before shearing with 250 mA of applied current to the electric hysteresis brake. GISAXS patterns also were obtained to assess long-range order with the beam parallel (FIG. 4B) and perpendicular (FIG. 4C) to the direction of shear. The distinct peak present in FIG. 4B and the absence of a corresponding feature in FIG. 4C suggest that the alignment propagates through the thickness of the film and extends over a macroscopic distance.

TABLE 3
Quantification of nanostructure with Herman's orientation parameter
(S_{2D}) and defect densities for AFM phase images of films.

| Sample | | | Defect density |
|---|---|---|---|
| No. | | S_{2D} | (defect-pairs/μm²) |
| 1 | FIG. 4a | 0.91 | 279 |
| 2A | FIG. 5b | 0.26 | 356 |
| 2B | FIG. 5c | 0.04 | 539 |
| 2C | FIG. 5d | 0.77 | 438 |
| 2D | FIG. 5e | 0.91 | 291 |
| 2E | FIG. 5f | 0.94 | 205 |
| 3A | FIG. 6b | 0.66 | 463 |
| 3B | FIG. 6c | 0.94 | 263 |
| 3C | FIG. 6d | 0.87 | 498 |
| 4 | FIG. 7a | 0.71 | 617 |
| 4 | FIG. 7b | >0.99 | 5 |

One benefit of using an electric hysteresis brake is that the torque, and therefore the shear stress applied to the film, is controllable. The shear stress was approximated from the brake's torque, radius of the roller (˜12.7 mm), and contact area between the PDMS and the film (˜80 mm²). FIG. 5a shows the relationship between the current and the resulting torque, as well as the approximate shear stress. To investigate the effect of shear strength on nanostructure alignment, PS-PI-PS solutions were cast and sheared with different applied currents to the electric hysteresis brake. Five films were prepared: a control cast without the use of a roller (FIG. 5B), a ‘no-brake’ sample rolled without the brake connected to the axle (FIG. 5C), and three films sheared by IRSA with applied currents of 1 mA, 190 mA, and 270 mA (FIGS. 5D-F). The control had an S_{2D} of 0.26 and 356 defect-pairs/μm²; the no-brake film had an S_{2D} of 0.04 and 539 defect-pairs/μm²; the 1 mA film had an S_{2D} of 0.77 and 438 defect-pairs/μm²; the 190 mA film had an S_{2D} of 0.91 and 291 defect-pairs/μm²; the 270 mA film had an S_{2D} of 0.94 and 205 defect-pairs/μm². Interestingly, the no-brake film had a noticeably different nanopattern versus the control, with an appreciably higher defect density despite both AFM phase images having minimal alignment. The higher defect density for the no-brake film in comparison to the control suggests that, even without appreciable shear, interactions between PDMS and a wet film disrupt the nanostructure that the BP would form if dried without contact from the elastomer. In comparison to the no-brake film, the relatively small shear stress produced by 1 mA imparted a considerable degree of directionality to the cylinders. A further increase in shear stress with the 190 mA and 270 mA samples corresponded to an increase in S_{2D} and a decrease in defect density.

The effectiveness of IRSA to orient nanostructures rapidly across all shear strengths likely is related to the quantity of solvent present when the film interacts with the roller. Indeed, the solvent content in the solvent-containing film was found to be an important component for IRSA to impart sufficient alignment to the BP nanostructure, as shearing with the roller had no impact on nanostructure when the film was dry. When a film had too much solvent, the PDMS did not maintain traction with the surface, producing a ‘squeegee effect’ that disrupted the wet film, resulting in no observable film after the roller.

The impact of solvent content on the quality of alignment was probed further by pausing the stage between casting and interaction with the roller, thereby changing the wet film concentration upon shearing (FIG. 6). First, a basis of comparison was established by creating a ‘drying curve’ for the polymer system cast at the speed being probed (FIG. 6a). A solution of 4 wt. % PS-PI-PS in toluene was cast in triplicate at 20 mm/s with the thicknesses of the drying films measured inline using a reflectance spectrometer attached to the moving stage. Then, three PS-PI-PS films were flow coated from the same solution at the same speed and aligned by IRSA with varied pauses between casting and shearing (FIGS. 6b-d). The total times between casting and shearing for the three films were 5.75 s, 7.75 s, and 9.75 s, and the drying films had approximate thicknesses of 4.6 μm, 3.6 μm, and 2.6 μm, respectively, when sheared by the roller. S_{2D} for each image suggests nanostructure alignment improved from 5.75 s to 7.75 s and worsened from 7.75 s to 9.75 s (S_{2D} of 0.66, 0.94, and 0.87, respectively). Defect densities across the 5.75 s, 7.75 s, and 9.75 s films followed a similar trend, with 463 defect-pairs/μm², 263 defect-pairs/μm², and 498 defect-pairs/μm², respectively. The differences in degree of alignment and number of defects were attributed to interplay between polymer chain mobility and solution viscosity. At more dilute concentrations, the polymer chains had higher mobility. However, at a lower polymer concentration, the solution viscosity was reduced, which had a possible negative impact on the extent of nanostructure orientation.

BP solutions cast and sheared by IRSA with parameters that yield weakly oriented patterns (e.g., too little solvent in the film when interacting with the roller) may be annealed to produce highly aligned structures with almost no defects. For example, a sample was fabricated with IRSA such that the film would be too dry to form a well-oriented nanostructure, and the corresponding AFM phase image of the unmodified film in FIG. 7A shows only a slight directionality with an S_{2D} of 0.71. Then, the film was subjected to SVA with chloroform and swelled from an initial thickness of ˜120 nm to ˜170 nm for 12 h, followed by opening the annealing chamber lid to quickly de-swell the film. An AFM phase image of the annealed film shows a strongly aligned pattern (S_{2D}>0.99) and minimal defects (5 defect-pairs/μm²) (FIG. 7B). Although SVA typically increases short-range order the thin-film nanostructure, long-range order of such a film does not improve, resulting “fingerprint” patterns. The specimen herein exhibited long-range order beyond the typical fingerprint pattern for an unsheared PS-PI-PS film after undergoing a similar annealing process. This result suggests that IRSA can align BPs rapidly across a wide range of conditions, including when films show minimal order. While not being bound to any particular mechanism or causation, it is believed that IRSA may impart a ‘latent alignment’ preference to the polymer chains akin to photothermal shear-based ‘ordering pathways,’ such as are described in the literature with respect to a molecular alignment that biases the nature of the nanostructure developed in the film upon subsequent annealing. If combined with a continuous-operation-compatible annealing process with enhanced ordering kinetics such as Direct Immersion Annealing, Cold Zone Annealing, or Raster Solvent Vapor Annealing, IRSA may be particularly well suited for fabricating low-defect aligned BP thin films at commercially viable speeds.

For Sample Nos. 7-11, the IRSA process was repeated as above and the process conditions are summarized in Table 2. For Sample Nos. 7-8, solutions of PS or PS-PEO in toluene were used to form thin films that show alignment of any nanostructures from the polymer. FIGS. 10A and 10B shows AFM height images of Sample No. 8A before and after solvent vapor annealing (SVA) with toluene and water vapor mixture at room temperature of IRSA-processed PS-PEO thin film formed from 1 wt. % starting solution.

FIG. 11 shows an AFM height image of Sample No. 9, IRSA-processed composite, composed of PS-PEO and Zn acetate, and thin films casted from Toluene and methanol as solvent mixture present in an amount of 9:1 by weight. FIG. 11 shows that the nanostructure from the PS-PEO was aligned when cast in the presence of the Zn salt as a blend.

FIG. 12 show AFM phase image of Sample No. 10, IRSA-processed thin film of a blend of PS-PI-PS and PS present in a weight ratio of 9:1 and casted from toluene as a solvent. As shown in FIG. 12 the nanostructure from the PS-PI-PS was aligned when cast in the presence of the PS homopolymer as a blend.

Sample No. 11 was processed the same way as Sample No. 3B, except that the surface of the PDMS elastomeric pad on the roller was modified by the addition of a fluorinated chlorosilane monolayer, which resulted in an incompatibility between the PS-PI-PS polymer being sheared and the surface-modified elastomeric pad material, which in turn resulted in the destruction of the film. No further analysis was performed.

### Example 2: Nanowire Fabrication

Aligned nanowires were fabricated as follows: The aligned PS-P2VP film was annealed in a vacuum oven at 230° C. for 15 h and then submerged in 10 mM Na₂PtCl₄·xH₂O (Sigma-Aldrich, used as received) in 0.9 wt. % HCl (Sigma-Aldrich, used as received) for 15 min. The film was rinsed with deionized water to remove excess salt. Finally, the salt-doped film was processed by atmospheric-pressure plasma to form the nanowires.

Open-Air Atmospheric-Plasma Reactor: The plasma processing was performed in an open-air dielectric barrier discharge (DBD) plasma reactor that can etch polymers rapidly at ambient conditions. The custom-built DBD device was configured in a parallel-plate arrangement, with one electrode connected to an alternating-current, high-voltage, power supply (Information Unlimited) and the other electrode connected to the ground. Both electrodes were made of stainless steel and were covered with quartz dielectric discs 2 mm thick. The air gap between the quartz surfaces was fixed at 1.5 mm, and the silicon wafer with the gold salt-doped film was positioned on the grounded (bottom) electrode. Air plasma was excited at a frequency of 23.5 kHz and a peak-to-peak voltage of 23 kV. The air plasma covered a total area of ˜16 cm². The film was exposed to plasma for 2 min.

To demonstrate the flexibility and utility of IRSA, the method was applied to align PS-P2VP films that were subsequently employed to fabricate aligned metal nanowires. Solvent systems for PS-P2VP coatings were assessed for the production of an aligned parallel-cylinder morphology with IRSA; the use of toluene as the solvent resulted in micelle formation, whereas THF produced the desired parallel-cylinder nanostructure (FIG. 8A). The nanostructure was improved further with the addition of a small quantity of toluene to the solution (19:1 w:w ratio of THF:toluene), likely because the toluene slightly lowers the solution volatility versus pure THF (FIG. 8B-8C). The resulting sheared film was thermally annealed at 230° C. for 15 h. The annealed film was submerged in 10 mM Na₂PtCl₄·xH₂O in 0.9 wt. % HCl for 15 min and finally rinsed with deionized water to remove excess salt. A depth profile was measured by XPS with ion etching, which showed that the majority of the Pt ions were located in the first layer of the thin film (Table 1 and FIG. 3).

Open-air atmospheric-plasma then was used as a continuous-processing-compatible step to etch the polymer and leave platinum nanowires. In fabrication processes established in literature, nanowires generally are formed by etching the polymer from exposure to air or oxygen plasma under vacuum; however, the reduced pressure requirement presents challenges for use with continuous systems. Herein, the platinum salt-incorporated films were placed in a custom-built, DBD plasma reactor, operating in atmospheric air without an enclosure or additional gas feedthrough (FIG. 8A-B). Air plasma creates a mixture of highly oxidative species (e.g., atomic oxygen radicals upon electron impact dissociation of atmospheric dioxygen) that can etch polymeric substrates rapidly. The samples were exposed to air plasma for 2 min to remove the polymer and reveal the aligned nanowires. (FIG. 8C).

In summary, the inventors have developed and demonstrated a directed self-assembly method termed Inline Rolling Shear Alignment, or IRSA, to rapidly produce macroscopically aligned, block polymer, homopolymer, polymer blend, and polymer composite. The use of an elastomeric roller to apply shear uniquely enables a simple continuous-compatible process to orient nanostructures. Another distinctive aspect of IRSA is that the solvent from casting provides the chain mobility for directing the nanostructure. This process intensification circumvents the need to either heat films above the polymer's glass transition temperature or reintroduce solvent. Reducing or eliminating these steps may lessen the environmental impact of production by lowering both solvent waste generation and energy requirements. With poly(styrene-b-isoprene-b-styrene) as a model triblock polymer system, solvent content was found to be an important factor for effectively aligning block polymers, with optimal conditions likely balancing chain mobility and viscosity. Subsequent solvent vapor annealing was demonstrated as an effective method to produce highly aligned nanostructures (S_{2D}>0.99) with minimal defects (5 defect-pairs/μm²) from films that appear poorly oriented, suggesting that IRSA imparts a latent alignment onto the polymer chain assemblies. The adaptability of IRSA was exhibited by aligning a diblock polymer system, poly(styrene-b-2-vinylpyridine). The resulting film was used as a template to produce oriented inorganic nanowires by salt doping and open-air atmospheric-pressure plasma etching, another important advance toward continuous-compatible processing. IRSA and atmospheric-pressure plasma processing could enable fully roll-to-roll production and unlock new, practical routes to manufacturing macroscopically aligned nanostructures.

1. An inline rolling shear alignment (IRSA) coating device comprising:
(i) a coating head for disposing a solvent-containing film having a starting amount of solvent on a substrate in a deposition area;
(ii) a roller comprising a rigid axle having a pad radially disposed thereon, the pad in contact with the film at a film-roller contact area located a distance from the deposition area, wherein there is a desired amount of friction between a portion of a surface of the pad and the film;
(iii) means for causing relative motion between the film and the roller in an operation direction at a film velocity and for causing the roller to rotate in a direction such that the roller in the film-roller contact area has a tangential velocity in the same direction as the film velocity;
(iv) a resistance member coupled to the roller, the resistance member configured to apply a rotation-opposing bias to the roller in an amount sufficient to cause the roller to apply a desired amount of shear stress to the film in the film-roller contact area during rotation of the roller,
wherein the distance between the deposition area and the film-roller contact area is sufficient to permit a predetermined amount of evaporation of the solvent in the solvent-containing film between the deposition area and the film-roller contact area at the film velocity such that the solvent-containing film in the contact area of the film comprises a residual amount of solvent that is less than the starting amount of solvent.

2. The IRSA coating device according to claim 1, further comprising a resistance member controller for controlling the shear stress that is sufficient to align nanostructures of the film.

3. The IRSA coating device according to claim 1, wherein the film comprises homopolymer, block (co) polymer, and blends thereof, and composites comprising a mixture of polymeric and non-polymeric material, wherein the block copolymer comprises a diblock copolymer, a triblock copolymer, a multiblock copolymer, or a star block copolymer.

4. The IRSA coating device according to claim 2, wherein the block copolymer is selected from the group consisting of poly(styrene-b-isoprene-b-styrene), poly(styrene-b-2-vinyl pyridine), poly(styrene-b-ethylene oxide), poly(styrene-b-dimethylsiloxane), and poly(styrene-b-methyl methacrylate).

5. The IRSA coating device according to claim 1, wherein the pad is made from a functionalized or non-functionalized polymer selected from the group consisting of natural rubber, polyisoprenes, polybutadienes, polychloroprenes, polysiloxanes, fluorosilicones, fluoroelastomers, polypropylene, and polystyrene based elastomeric copolymers and blends.

6. The IRSA coating device according to claim 1, wherein an amount of shear stress applied to the film at the film-roller contact area is in the range of 1 to 250 kPa.

7. The IRSA coating device according to claim 1, wherein the resistance member comprises an external electromagnetic brake, a frictional brake, or an internal resistance.

8. The rolling shear alignment coating device according to claim 1, wherein the pad comprises a chemically or physically patterned surface.

9. The rolling shear alignment coating device according to claim 1, wherein the solvent-containing film comprises a mixture of two or more solvents.

10. A method of producing a nanostructured film, comprising:
(i) providing the IRSA coating device of claim 1;
(ii) causing relative motion between the coating head and the substrate, and applying with the coating head on the substrate the solvent-containing film having the starting amount of solvent and a polymeric material for forming the nanostructured film,
(iii) contacting a portion of a surface of a pad radially disposed over the roller to the solvent-containing film in the film-roller contact area at a temperature; and
(iv) applying a sufficient amount of rotation-opposing bias to the roller with the resistance member such that the shear stress applied by the roller to the film in the film-roller contact area during rotation of the roller causes formation of a nanostructured film; and
(v) optionally annealing the nanostructured film.

11. The method according to claim 10, wherein the rotation-opposing bias is applied to the roller via an external electromagnetic brake, a frictional brake, or an internal resistance.

12. The method according to claim 11 further comprising controlling the shear stress by adjusting one or more of: amount of rotation-opposing bias applied by the brake, overall radius of the roller, and amount of area defined by the film-roller contact area.

13. The method according to claim 11, wherein the resistance member comprises an electric hysteresis brake, comprising adjusting the shear stress by adjusting an amount of current applied to the electric hysteresis brake using the resistance member controller.

14. The method according to claim 10 further comprising adjusting the amount of residual solvent in the film-roller contact area by adjusting the film speed.

15. The method according to claim 10 further comprising adjusting the amount of residual solvent in the film-roller contact area by adjusting the distance between the film-roller contact area and the coating head.

16. The method according to claim 10, further comprising annealing the nanostructured film resulting from steps (i)-(iii) to form an annealed nanostructured film.

17. A method for forming an inorganic nanostructure comprising:
(i) using the nanostructured film of claim 10 as a template for creating an inorganic nanostructure;
(ii) doping the nanostructured film to form an inorganic compound-doped film; and
(iii) etching the inorganic compound-doped film to form the metal nanostructure, wherein etching comprises chemical etching, plasma etching, or reactive ion etching.

18. The method of claim 17, where the inorganic compound is sodium tetrachloroplatinate (II) hydrate or chloroauric acid, sodium tetrachloropalladate, potassium ferricyanide, potassium hexacyanocobaltate (III), copper (II) chloride, nickel (II) chloride, zinc chloride, silicon tetrachloride, or tetraethyl orthosilicate.

19. The method of claim 17, wherein the step of doping comprises submerging the nanostructured film in a solution of inorganic compound or doping the nanostructured film by physical vapor deposition.

20. The method of claim 17, wherein the step of doping comprises providing a pre-doped nanostructured film formed by pre-doping the film with the inorganic compound in the initial casting solution.

21. A method of producing a nanostructured film, comprising the steps of:
a) disposing, with a film applicator, a solvent-containing film on a substrate, the solvent-containing film as disposed having a starting amount of solvent and a polymeric material for forming a hierarchical structure;
b) applying, with a force applicator, a shear stress to the solvent-containing film after first permitting a predetermined amount of evaporation of the solvent in the solvent-containing film between the disposing step and the shear stress applying step, the predetermined amount of evaporation operative to reduce a glass transition temperature of the solvent-containing film below an ambient temperature or to change an otherwise crystalline or semi-crystalline material in the solvent-containing film to an amorphous state.

22. (canceled)
